(19) United States
(12) Patent Application Publication
(10) Pub. No.: US 2023/0014485 A1
(43) Pub. Date: Jan. 19, 2023

(54) Transaction processing method, transaction processing system, electronic apparatus, and storage medium

(71) Applicant: LAU SARA LING, Hong Kong (CN)

(72) Inventors: Gaolin WU, Schaumburg, IL (US); LAU SARA LING, Hong Kong (CN); Chengwei Mo, Guilin (CN); Brian McElroy, Hong Kong (CN)

(21) Appl. No.: 17/787,386

(22) PCT Filed: Mar. 16, 2021
(86) PCT No.: PCT/CN2021/080906

§ 371 Date: Jun. 20, 2022

(30) Foreign Application Priority Data
Mar. 16, 2020 (HK) 320200043315

(51) Int. Cl. G06Q 50/18; G06Q 20/40

(52) U.S. Cl. CPC G06Q 50/184; G06Q 20/401

(57) ABSTRACT

A transaction processing method comprises: performing pre-processing on at least one piece of first-type transaction object information (102); transmitting the first-type transaction object information to a first processing region to undergo processing on the basis of a first-type operation instruction (104); transmitting the first-type transaction object information that has been processed on the basis of the first-type operation instruction in the first processing region to a second processing region to undergo processing on the basis of a second-type operation instruction (106); and transmitting second-type transaction object information obtained from the first-type transaction object information to a third processing region to undergo processing on the basis of a third-type operation instruction (108). Also provided are a transaction processing system, an electronic apparatus, and a readable storage medium.

### TECHNICAL FIELD

The present disclosure relates generally to the field of information processing/transaction processing, and more particularly to a transaction processing method, a transaction processing system, an electronic apparatus, and a storage medium.

### BACKGROUND

Intellectual property is a precious asset that must be managed, protected, commoditized, and realized in value. Intellectual property marketing activities include: sale, purchase, licensing, transfer, technical transfer licensing, merchandising programs, franchising, brand extension licensing, collaborative R&D, etc.

These transaction patterns involve large amounts of money, many parties involved in the negotiation, and the transaction flow is complex. In the prior art, intellectual property transactions are generally handled by professionals, resulting in low transaction processing efficiency. As a result, IP transactions are inactive and lack liquidity.

With the continuous development of the market, intellectual property securitization transactions have appeared recently. However, the information processing/transaction processing of financial transaction systems in the prior art is difficult to directly apply to intellectual property transactions.

### SUMMARY OF THE INVENTION

To solve at least one of the above technical problems, the present disclosure provides a transaction processing method, a transaction processing system, an electronic apparatus and a storage medium.

The transaction processing method, transaction processing system, electronic apparatus, and storage medium of the present disclosure are implemented by the following technical solutions.

According to one aspect of the present disclosure, there is provided a transaction processing method comprising:

preprocessing at least one first-type transaction object information, wherein the first-type transaction object information after being preprocessed comprises at least feature information and number of shares identification information;

transmitting the first-type transaction object information after being preprocessed to a first processing region, wherein the first-type transaction object information in the first processing region is processed based on at least one first-type operation instruction, the first-type operation instruction comprises obtaining predetermined number of shares of first-type transaction objects; updating the number of shares identification information of the first-type transaction object information in the first processing region based on at least one first-type operation instruction;

transmitting updated first-type transaction object information to the second processing region, wherein the first-type transaction object information in the second processing region is processed based on at least one second-type operation instruction, the second-type operation instruction comprises obtaining predetermined number of shares of first-type transaction objects; updating the number of shares identification information of the first-type transaction object information in the second processing region based on at least one second-type operation instruction; and

transmitting at least one second-type transaction object information to a third processing region, wherein the second-type transaction object information is processed based on at least one third-type operation instruction, the third-type operation instruction comprises obtaining predetermined number of second-type transaction objects; the second-type transaction object information comprises at least feature information and quantity information; updating the quantity information of at least one second-type transaction object information in the third processing region based on at least one third-type operation instruction.

With regard to the transaction processing method according to at least one embodiment of the present disclosure, the second-type transaction object information is obtained based on the predetermined number of shares of first-type transaction object information obtained by at least one first-type operation instruction and/or at least one second-type operation instruction.

With regard to the transaction processing method according to at least one embodiment of the present disclosure, the first-type transaction object information and the second-type transaction object information are different types of transaction object information.

With regard to the transaction processing method according to at least one embodiment of the present disclosure, the first-type transaction object information further comprises identity identification information, and the second-type transaction object information comprises the identity identification information of the first-type transaction object information.

With regard to the transaction processing method according to at least one embodiment of the present disclosure, the first-type transaction object information further comprises price identification information, the first-type operation instruction comprises a price sub-instruction; the price sub-instruction of the first-type operation instruction is compared with the price identification information of the first-type transaction object information in the first processing region, and if a price of the price sub-instruction is the same as a price in the price identification information or a difference between the price in the price sub-instruction and the price in the price identification information is within a preset range, the first-type transaction object information in the first processing region is processed by the first-type operation instruction.

With regard to the transaction processing method according to at least one embodiment of the present disclosure, the second-type operation instruction comprises a price sub-instruction; the price sub-instruction of the second-type operation instruction is compared with the price identification information of the first-type transaction object information in the second processing region, and if a price of the price sub-instruction is the same as a price in the price identification information or a difference between the price in the price sub-instruction and the price in the price identification information is within a preset range, the first-type transaction object information in the second processing region is processed by the second-type operation instruction.

With regard to the transaction processing method according to at least one embodiment of the present disclosure, the second-type transaction object information further comprises price identification information, the third-type operation instruction comprises a total price sub-instruction, and the total price sub-instruction of the third-type operation instruction is matched with the price identification information in the second-type transaction object information in the third processing region to enable the third-type operation instruction to obtain a predetermined number of second-type transaction objects.

With regard to the transaction processing method according to at least one embodiment of the present disclosure, the second-type transaction object information further comprises price identification information, the third-type operation instruction comprises first-type transaction object information, and the price identification information and the number of shares identification information in the first-type transaction object information of the third-type operation instruction are matched with the price identification information in the second-type transaction object information in the third processing region to enable the third-type operation instruction to obtain a predetermined number of second-type transaction objects.

With regard to the transaction processing method according to at least one embodiment of the present disclosure, the first-type transaction object obtained by the first-type operation instruction or the second-type operation instruction is partially or fully transmittable to the second processing region.

With regard to the transaction processing method according to at least one embodiment of the present disclosure, the price identification information in the first-type transaction object information of the first-type transaction object obtained by the first-type operation instruction or the second-type operation instruction can be modified such that the first-type transaction object information of the first-type transaction object obtained by the first-type operation instruction or the second-type operation instruction comprises modified price identification information.

With regard to the transaction processing method according to at least one embodiment of the present disclosure, the identity identification information is of a non-modifiable type.

With regard to the transaction processing method according to at least one embodiment of the present disclosure, the first-type transaction object information after being preprocessed is transmitted to the first processing region via a user operation terminal device having a first identity type, the first-type operation instruction can be generated via a user operation terminal device having a second identity type and/or a third identity type and enter into the first processing region;

the second-type operation instruction can be generated via a user operation terminal device having a second identity type, a third identity type and/or a fourth identity type and enter into the second processing region;

the third-type operation instruction can be generated via a user operation terminal device having a second identity type and/or a fourth identity type and enter into the third processing region.

With regard to the transaction processing method according to at least one embodiment of the present disclosure, a user having a third identity type is configured to obtain a timestamp based on a predetermined number of first-type transaction objects obtained by a first-type operation instruction of the user such that a first-type transaction object configured to obtain a timestamp is allowed to be transmitted to the second processing region after a preset time.

With regard to the transaction processing method according to at least one embodiment of the present disclosure, a user having a second identity type transmits the second-type transaction object information of a second-type transaction object obtained based on the first-type transaction object obtained by the first-type operation instruction or the second-type operation instruction of the user to the third processing region.

With regard to the transaction processing method according to at least one embodiment of the present disclosure, when the price in the price identification information in the first-type transaction object information in the second processing region is greater than or greater than or equal to a first threshold, the first processing region allows for receiving a first-type transaction object information after a new preprocessing, or allows a user having the first identity type, the second identity type and/or the third identity type to transmit the first-type transaction object information of the first-type transaction object obtained by the user using the first acquisition instruction to the second processing region.

With regard to the transaction processing method according to at least one embodiment of the present disclosure, when the price in the first-type transaction object information in the second processing region is less than or less than or equal to a second threshold, the second processing region generates a prompt instruction, and the prompt instruction is sent to a terminal device of the user having a second-type identity.

With regard to the transaction processing method according to at least one embodiment of the present disclosure, the first-type transaction object information after a new preprocessing is transmitted to the first processing region via a user operation terminal device having a first identity type.

According to another aspect of the present disclosure, there is provided a transaction processing system comprising:

a preprocessing device for preprocessing at least one first-type transaction object information, wherein the first-type transaction object information after being preprocessed comprises at least feature information and number of shares identification information;

a first processing device, wherein the preprocessing device transmits the first-type transaction object information after being preprocessed to the first processing device, the first processing device processes the first-type transaction object information based on received at least one first-type operation instruction, the first-type operation instruction comprises obtaining predetermined number of shares of first-type transaction objects; the first processing device updates the number of shares identification information of the first-type transaction object information in the first processing device based on at least one first-type operation instruction;

a second processing device, wherein the first processing device transmits updated first-type transaction object information to the second processing device, the second processing device processes the first-type transaction object information based on received at least one second-type operation instruction, the second-type operation instruction comprises obtaining predetermined number of shares of first-type transaction objects; the second processing device updates the number of shares identification information of the first-type transaction object information in the second processing device based on at least one second-type operation instruction; and

a third processing device, wherein the third processing device receives at least one second-type transaction object information, the third processing device processes the second-type transaction object information based on received at least one third-type operation instruction, the third-type operation instruction comprises obtaining predetermined number of second-type transaction objects, the second-type transaction object information comprises at least feature information and quantity information; the third processing device updates the quantity information of at least one second-type transaction object information in the third processing device based on at least one third-type operation instruction.

With regard to the transaction processing system according to at least one embodiment of the present disclosure, the second-type transaction object information is obtained based on the predetermined number of shares of first-type transaction object information obtained by at least one first-type operation instruction and/or at least one second-type operation instruction.

With regard to the transaction processing system according to at least one embodiment of the present disclosure, the first-type transaction object information and the second-type transaction object information are different types of transaction object information.

With regard to the transaction processing system according to at least one embodiment of the present disclosure, the first-type transaction object information further comprises identity identification information, and the second-type transaction object information comprises the identity identification information of the first-type transaction object information.

With regard to the transaction processing system according to at least one embodiment of the present disclosure, the first-type transaction object information further comprises price identification information, the first-type operation instruction comprises a price sub-instruction; the first processing device compares the price sub-instruction of the first-type operation instruction with the price identification information of the first-type transaction object information in the first processing device, and if a price of the price sub-instruction is the same as a price in the price identification information or a difference between the price in the price sub-instruction and the price in the price identification information is within a preset range, the first-type transaction object information in the first processing device is processed by the first-type operation instruction.

With regard to the transaction processing system according to at least one embodiment of the present disclosure, the second-type operation instruction comprises a price sub-instruction, and the second processing device compares the price sub-instruction of the second-type operation instruction with the price identification information of the first-type transaction object information in the second processing device, and if a price of the price sub-instruction is the same as a price in the price identification information or a difference between the price in the price sub-instruction and the price in the price identification information is within a preset range, the first-type transaction object information in the second processing device is processed by the second-type operation instruction.

With regard to the transaction processing system according to at least one embodiment of the present disclosure, the second-type transaction object information further comprises price identification information, the third-type operation instruction comprises a total price sub-instruction, and the third processing device matches the total price sub-instruction of the third-type operation instruction with the price identification information in the second-type transaction object information in the third processing device to enable the third-type operation instruction to obtain a predetermined number of second-type transaction objects.

With regard to the transaction processing system according to at least one embodiment of the present disclosure, the second-type transaction object information further comprises price identification information, the third-type operation instruction comprises first-type transaction object information, and the third processing device matches the price identification information and the number of shares identification information in the first-type transaction object information of the third-type operation instruction with the price identification information in the second-type transaction object information in the third processing device to enable the third-type operation instruction to obtain a predetermined number of second-type transaction objects.

With regard to the transaction processing system according to at least one embodiment of the present disclosure, the first-type transaction object obtained by the first-type operation instruction or the second-type operation instruction is partially or fully transmittable to the second processing device.

With regard to the transaction processing system according to at least one embodiment of the present disclosure, the price identification information in the first-type transaction object information of the first-type transaction object obtained by the first-type operation instruction or the second-type operation instruction can be modified such that the first-type transaction object information of the first-type transaction object obtained by the first-type operation instruction or the second-type operation instruction comprises modified price identification information.

With regard to the transaction processing system according to at least one embodiment of the present disclosure, the identity identification information is of a non-modifiable type.

With regard to the transaction processing system according to at least one embodiment of the present disclosure, the first-type transaction object information after being preprocessed is transmitted to the first processing device via a user operation terminal device having a first identity type, the first-type operation instruction can be generated via a user operation terminal device having a second identity type and/or a third identity type and enter into the first processing device;

the second-type operation instruction can be generated via a user operation terminal device having a second identity type, a third identity type and/or a fourth identity type and enter into the second processing device;

the third-type operation instruction can be generated via a user operation terminal device having a second identity type and/or a fourth identity type and enter into the third processing device.

With regard to the transaction processing system according to at least one embodiment of the present disclosure, a predetermined number of shares of first-type transaction objects obtained by a user having a third identity type based on a first-type operation instruction of the user is configured to obtain a timestamp by the first processing device such that the first-type transaction objects configured to obtain a timestamp is allowed to be transmitted to the second processing device after a preset time.

With regard to the transaction processing system according to at least one embodiment of the present disclosure, a user having a second identity type transmits the second-type transaction object information of a second-type transaction object obtained based on the first-type transaction object obtained by the first-type operation instruction or the second-type operation instruction of the user to the third processing device.

With regard to the transaction processing system according to at least one embodiment of the present disclosure, when the price in the price identification information in the first-type transaction object information in the second processing device is greater than or greater than or equal to a first threshold, the first processing device allows for receiving a first-type transaction object information after a new preprocessing, or allows a user having the first identity type, the second identity type and/or the third identity type to transmit the first-type transaction object information of the first-type transaction object obtained by the user using the first acquisition instruction to the second processing device.

With regard to the transaction processing system according to at least one embodiment of the present disclosure, when the price in the first-type transaction object information in the second processing device is less than or less than or equal to a second threshold, the second processing device generates a prompt instruction, and the prompt instruction is sent to a terminal device of the user having a second-type identity.

With regard to the transaction processing system according to at least one embodiment of the present disclosure, the first-type transaction object information after a new preprocessing is transmitted to the first processing device via a user operation terminal device having a first identity type.

According to yet another aspect of the present disclosure, there is provided an electronic apparatus, comprising:

a memory storing an execution instruction; and a processor executing the execution instruction stored in the memory, whereby the processor performs the method according to any one of the above.

According to yet another aspect of the present disclosure, there is provided a readable storage medium having an execution instruction stored therein, wherein the execution instruction is configured to perform the method according to any one of the above when executed by a processor.

### BRIEF DESCRIPTION OF THE DRAWINGS

The accompanying drawings illustrate exemplary embodiments of the present disclosure and, together with the description thereof, serve to explain the principles of the present disclosure, including these drawings to provide a further understanding of the present disclosure, and the drawings are included in this specification and constitute a part of this specification.

FIG. 1 is a schematic flowchart of a transaction processing method according to an embodiment of the present disclosure.

FIG. 2 is a structural schematic block diagram of an electronic apparatus having a transaction processing system according to an embodiment of the present disclosure.

### DETAILED DESCRIPTION

The present disclosure is further described in detail below with reference to the accompanying drawings and embodiments. It can be understood that the specific embodiments described herein are intended to explain the relevant content only rather than limit the present disclosure. In addition, it should be noted that, for ease of description, only those parts related to the present disclosure are shown in the accompanying drawings.

It should be noted that, in absence of conflict, the embodiments of the present disclosure and the features in the embodiments may be combined with each other. The technical solutions of the present disclosure will be described in detail below with reference to the accompanying drawings and in combination with the embodiments.

Unless otherwise stated, the exemplary embodiments/examples illustrated will be understood as exemplary features providing various details of some ways in which the technical concept of the present disclosure may be implemented in practice. Thus, unless otherwise stated, the features of various embodiments/examples may additionally be combined, separated, interchanged, and/or rearranged without departing from the technical concept of the present disclosure.

The use of cross-hatching and/or shadows in the figures is typically used to render boundaries between adjacent components clear. As such, unless stated otherwise, the presence or absence of cross-hatching or shadows does not convey or represent any preference or requirement for a particular material, material property, size, proportion, commonality between the illustrated components and/or any other characteristic, attribute, property, etc. of the component. Further, in the drawings, the dimensions and relative dimensions of the components may be exaggerated for clarity and/or descriptive purposes. While the exemplary embodiments may be implemented differently, specific process sequences may be performed in a different order than that described. For example, two processes described consecutively may be performed substantially simultaneously or in an order opposite to the order described. In addition, like reference numerals refer to like parts.

When a component is referred to as being “on,” or “above,” “connected to,” or “coupled to” another component, the component may be directly on the other component, directly connected to, or directly bonded to the other component, or intermediate components may be present. However, when a component is referred to as being “directly on,” “directly connected to,” or “directly bonded to” another component, there are no intermediate components present. For this purpose, the term “connection” may refer to a physical connection, an electrical connection, etc., with or without an intermediate component.

The terminology used herein is for the purpose of describing particular embodiments and is not intended to be limiting. As used herein, the singular forms “a,” “an,” and “the” are intended to include the plural forms as well, unless the context clearly indicates otherwise. Furthermore, the terms “includes”, “including,” “comprises,” and/or “comprising” and variations thereof used in this specification specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” “approximately,” and similar terms are used as terms of approximation and not as terms of degree, and are intended to account for the inherent deviations in measured, calculated and/or provided values that would be recognized by those of ordinary skill in the art.

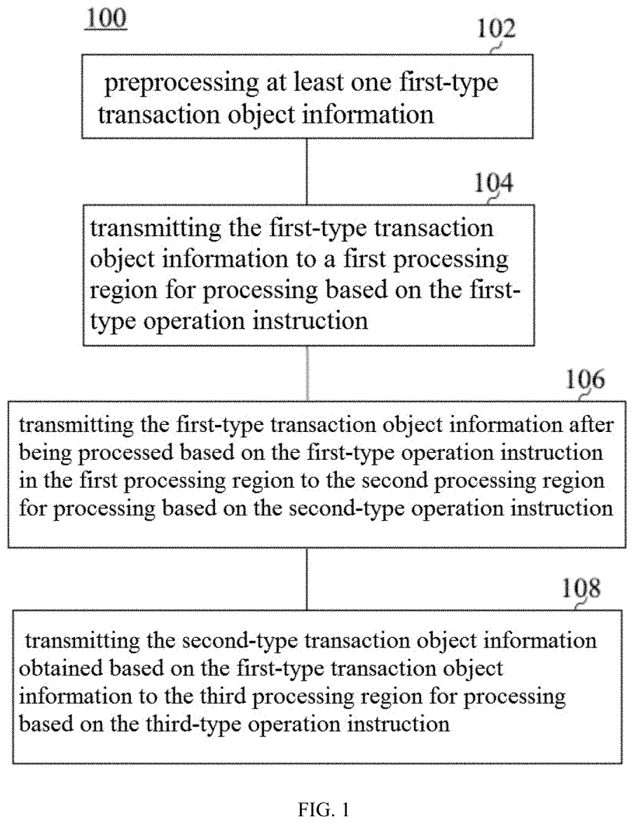

The transaction processing method 100 according to one embodiment of the present disclosure, as shown in FIG. 1, includes:

102, preprocessing at least one first-type transaction object information, wherein the first-type transaction object information after being preprocessed comprises at least feature information and number of shares identification information;

104, transmitting the first-type transaction object information after being preprocessed to a first processing region, wherein the first-type transaction object information in the first processing region is processed based on at least one first-type operation instruction, the first-type operation instruction comprises obtaining predetermined number of shares of first-type transaction objects;

updating the number of shares identification information of the first-type transaction object information in the first processing region based on at least one first-type operation instruction;

106, transmitting updated first-type transaction object information to the second processing region, wherein the first-type transaction object information in the second processing region is processed based on at least one second-type operation instruction, the second-type operation instruction comprises obtaining predetermined number of shares of first-type transaction objects;

updating the number of shares identification information of the first-type transaction object information in the second processing region based on at least one second-type operation instruction; and

108, transmitting at least one second-type transaction object information to a third processing region, wherein the second-type transaction object information is processed based on at least one third-type operation instruction, the third-type operation instruction comprises obtaining predetermined number of second-type transaction objects; the second-type transaction object information comprises at least feature information and quantity information; updating the quantity information of at least one second-type transaction object information in the third processing region based on at least one third-type operation instruction.

With regard to the transaction processing method 100 according to the above embodiments, the second-type transaction object information is obtained based on the predetermined number of shares of first-type transaction object information obtained by at least one first-type operation instruction and/or at least one second-type operation instruction.

The first-type transaction object may be intellectual property, and the first-type transaction object information may be intellectual property information, such as trademark right information, patent right information, copyright information, geographical indication information, etc., and feature information in the first-type transaction object information is, for example, validity period information, technical content information, and/or legal status information, etc., of the patent right.

With regard to the number of shares identification information in the first-type transaction object information, by taking the patent right as an example, the license rights to use one patent right can be set to a predetermined number of shares, for example, if the license rights to use one patent right are set to 5 shares, the number of shares identification information of the license rights to use the patent right is 5, that is, the patent right can be implemented by five licensees. In this example, the first-type transaction object is the license rights to use the patent right. The identity identification information in the first-type transaction object information is, for example, patent number information of the patent right.

The first-type transaction object may also be a license right to use a trademark right, a license right to use a geographical indication, etc.

The preprocessing may be information extraction processing and/or information generation processing on the first-type transaction object information based on computer instructions or based on the information extraction model.

The first processing region, the second processing region, and the third processing region may be different regions (devices) having storage modules and processing modules in a computer system or a network system, or separate regions (devices) having storage modules and processing modules, such as storage devices and processors in a computer system.

The second-type transaction object may be commodities generated based on the first-type transaction object, and the commodities may be tangible commodities (e.g., products produced based on patent rights, chips, handheld devices, etc.), or intangible commodities (e.g., electronic movie tickets, etc.).

With regard to the transaction processing method 100 of the various embodiments described above, the first-type transaction object information and the second-type transaction object information are different types of transaction object information.

With regard to the transaction processing method 100 according to a preferred embodiment of the present disclosure, the first-type transaction object information further comprises identity identification information, and the second-type transaction object information comprises the identity identification information of the first-type transaction object information. The identity identification information of the first-type transaction object information is set in the second-type transaction object information.

With regard to the transaction processing method according to the above embodiment, the identity identification information is of a non-modifiable type.

With regard to the transaction processing method 100 of the various embodiments described above, the first-type transaction object information further comprises price identification information, the first-type operation instruction comprises a price sub-instruction; the price sub-instruction of the first-type operation instruction is compared with the price identification information of the first-type transaction object information in the first processing region, and if a price of the price sub-instruction is the same as a price in the price identification information or a difference between the price in the price sub-instruction and the price in the price identification information is within a preset range, the first-type transaction object information in the first processing region is processed by the first-type operation instruction.

The preset range may be preset by those skilled in the art.

With regard to the transaction processing method 100 of the various embodiments described above, preferably, the second-type operation instruction comprises a price sub-instruction; the price sub-instruction of the second-type operation instruction is compared with the price identification information of the first-type transaction object information in the second processing region, and if a price of the price sub-instruction is the same as a price in the price identification information or a difference between the price in the price sub-instruction and the price in the price identification information is within a preset range, the first-type transaction object information in the second processing region is processed by the second-type operation instruction.

The preset range may be preset by those skilled in the art.

With regard to the transaction processing method 100 of the various embodiments described above, preferably, the second-type transaction object information further comprises price identification information, the third-type operation instruction comprises a total price sub-instruction, and the total price sub-instruction of the third-type operation instruction is matched with the price identification information in the second-type transaction object information in the third processing region to enable the third-type operation instruction to obtain a predetermined number of second-type transaction objects.

With regard to the transaction processing method 100 of the various embodiments described above, preferably, the second-type transaction object information further comprises price identification information, the third-type operation instruction comprises first-type transaction object information, and the price identification information and the number of shares identification information in the first-type transaction object information of the third-type operation instruction are matched with the price identification information in the second-type transaction object information in the third processing region to enable the third-type operation instruction to obtain a predetermined number of second-type transaction objects.

With regard to the transaction processing method 100 of the various embodiments described above, preferably, the first-type transaction object obtained by the first-type operation instruction or the second-type operation instruction is partially or fully transmittable to the second processing region.

In the transaction processing method 100 described above, the price identification information in the first-type transaction object information of the first-type transaction object obtained by the first-type operation instruction or the second-type operation instruction can be modified such that the first-type transaction object information of the first-type transaction object obtained by the first-type operation instruction or the second-type operation instruction comprises modified price identification information.

With regard to the transaction processing method 100 of the various embodiments described above, preferably, the first-type transaction object information after being preprocessed is transmitted to the first processing region via a user operation terminal device having a first identity type, the first-type operation instruction can be generated via a user operation terminal device having a second identity type and/or a third identity type and enter into the first processing region;

the second-type operation instruction can be generated via a user operation terminal device having a second identity type, a third identity type and/or a fourth identity type and enter into the second processing region;

the third-type operation instruction can be generated via a user operation terminal device having a second identity type and/or a fourth identity type and enter into the third processing region.

The first identity type may be an issuer of the first-type transaction object information, the second identity type may be a producer that obtains the second-type transaction object based on the obtained first-type transaction object, the third identity type may be an institutional organization engaged in the transaction of the first-type transaction object, and the fourth identity type may be an individual identity.

Those skilled in the art will appreciate that different identity types may be represented by different digital codes so that the different identity types described above can be identified by the first processing region, the second processing region, and the third processing region.

With regard to the transaction processing method 100 according to the above embodiments, preferably, a user having a third identity type is configured to obtain a timestamp based on a predetermined number of first-type transaction objects obtained by a first-type operation instruction of the user such that a first-type transaction object configured to obtain a timestamp is allowed to be transmitted to the second processing region after a preset time.

With regard to the transaction processing method 100 of the various embodiments described above, preferably, a user having a second identity type transmits the second-type transaction object information of a second-type transaction object obtained based on the first-type transaction object obtained by the first-type operation instruction or the second-type operation instruction of the user to the third processing region.

With regard to the transaction processing method 100 of the various embodiments described above, preferably, when the price in the price identification information in the first-type transaction object information in the second processing region is greater than or greater than or equal to a first threshold, the first processing region allows for receiving a first-type transaction object information after a new preprocessing, or allows a user having the first identity type, the second identity type and/or the third identity type to transmit the first-type transaction object information of the first-type transaction object obtained by the user using the first acquisition instruction to the second processing region.

With regard to the transaction processing method 100 of the various embodiments described above, preferably, when the price in the first-type transaction object information in the second processing region is less than or less than or equal to a second threshold, the second processing region generates a prompt instruction, and the prompt instruction is sent to a terminal device of the user having a second-type identity.

The second threshold is less than the first threshold, and the first threshold and the second threshold may be preset by a person skilled in the art.

With regard to the transaction processing method 100 of the various embodiments described above, preferably, the first-type transaction object information after a new preprocessing is transmitted to the first processing region via a user operation terminal device having a first identity type.

In the above embodiments, the terminal device may be a computer device or various handheld electronic apparatuses.

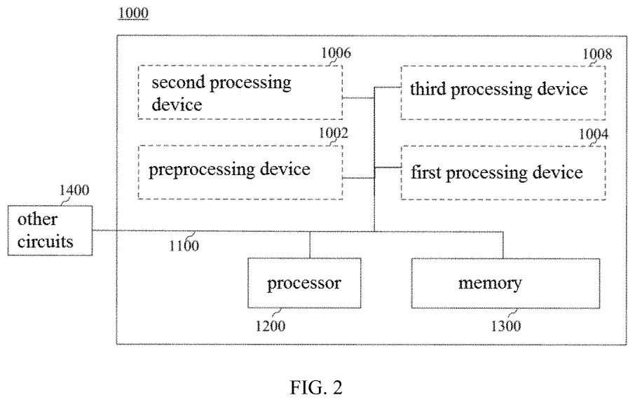

FIG. 2 is a schematic structural diagram of an electronic apparatus 1000 including the transaction processing system of the present disclosure.

The transaction processing system of the present disclosure may be included within the electronic apparatus 1000.

A transaction processing system according to one embodiment of the present disclosure comprises:

a preprocessing device 1002 for preprocessing at least one first-type transaction object information, wherein the first-type transaction object information after being preprocessed comprises at least feature information and number of shares identification information;

a first processing device 1004, wherein the preprocessing device 1002 transmits the first-type transaction object information after being preprocessed to the first processing device 1004, the first processing device 1004 processes the first-type transaction object information based on received at least one first-type operation instruction, the first-type operation instruction comprises obtaining predetermined number of shares of first-type transaction objects; the first processing device 1004 updates the number of shares identification information of the first-type transaction object information in the first processing device 1004 based on at least one first-type operation instruction;

a second processing device 1006, wherein the first processing device 1004 transmits updated first-type transaction object information to the second processing device 1006, the second processing device 1006 processes the first-type transaction object information based on received at least one second-type operation instruction, the second-type operation instruction comprises obtaining predetermined number of shares of first-type transaction objects; the second processing device 1006 updates the number of shares identification information of the first-type transaction object information in the second processing device 1006 based on at least one second-type operation instruction; and

a third processing device 1008, wherein the third processing device 1008 receives at least one second-type transaction object information, the third processing device 1008 processes the second-type transaction object information based on received at least one third-type operation instruction, the third-type operation instruction comprises obtaining predetermined number of second-type transaction objects, the second-type transaction object information comprises at least feature information and quantity information; the third processing device 1008 updates the quantity information of at least one second-type transaction object information in the third processing device 1008 based on at least one third-type operation instruction.

The first processing device 1004, the second processing device 1006, and the third processing device 1008 may include a processing module and a memory module, and even the first processing device, the second processing device, and the third processing device may share a memory module, each including a memory sub-module in the memory module.

With regard to the transaction processing system according to the above embodiments, the second-type transaction object information is obtained based on the predetermined number of shares of first-type transaction object information obtained by at least one first-type operation instruction and/or at least one second-type operation instruction.

With regard to the transaction processing systems of the various embodiments described above, the first-type transaction object information and the second-type transaction object information are different types of transaction object information.

With regard to the transaction processing systems of the various embodiments described above, preferably, the first-type transaction object information further comprises identity identification information, and the second-type transaction object information comprises the identity identification information of the first-type transaction object information.

With regard to the transaction processing systems of the various embodiments described above, preferably, the first-type transaction object information further comprises price identification information, the first-type operation instruction comprises a price sub-instruction; the first processing device 1004 compares the price sub-instruction of the first-type operation instruction with the price identification information of the first-type transaction object information in the first processing device 1004, and if a price of the price sub-instruction is the same as a price in the price identification information or a difference between the price in the price sub-instruction and the price in the price identification information is within a preset range, the first-type transaction object information in the first processing device 1004 is processed by the first-type operation instruction.

With regard to the transaction processing systems of the various embodiments described above, preferably, the second-type operation instruction comprises a price sub-instruction, and the second processing device 1006 compares the price sub-instruction of the second-type operation instruction with the price identification information of the first-type transaction object information in the second processing device 1006, and if a price of the price sub-instruction is the same as a price in the price identification information or a difference between the price in the price sub-instruction and the price in the price identification information is within a preset range, the first-type transaction object information in the second processing device 1006 is processed by the second-type operation instruction.

With regard to the transaction processing systems of the various embodiments described above, preferably, the second-type transaction object information further comprises price identification information, the third-type operation instruction comprises a total price sub-instruction, and the third processing device 1008 matches the total price sub-instruction of the third-type operation instruction with the price identification information in the second-type transaction object information in the third processing device 1008 to enable the third-type operation instruction to obtain a predetermined number of second-type transaction objects.

With regard to the transaction processing systems of the various embodiments described above, preferably, the second-type transaction object information further comprises price identification information, the third-type operation instruction comprises first-type transaction object information, and the third processing device 1008 matches the price identification information and the number of shares identification information in the first-type transaction object information of the third-type operation instruction with the price identification information in the second-type transaction object information in the third processing device 1008 to enable the third-type operation instruction to obtain a predetermined number of second-type transaction objects.

With regard to the transaction processing systems of the various embodiments described above, preferably, the first-type transaction object obtained by the first-type operation instruction or the second-type operation instruction is partially or fully transmittable to the second processing device 1006.

With regard to the transaction processing systems of the various embodiments described above, preferably, the price identification information in the first-type transaction object information of the first-type transaction object obtained by the first-type operation instruction or the second-type operation instruction can be modified (e.g., the user performs modification through the terminal device) such that the first-type transaction object information of the first-type transaction object obtained by the first-type operation instruction or the second-type operation instruction comprises modified price identification information.

With regard to the transaction processing systems of the various embodiments described above, preferably, the identity identification information is of a non-modifiable type.

According to a preferred embodiment of the present disclosure, the first-type transaction object information after being preprocessed is transmitted to the first processing device 1004 via a user operation terminal device having a first identity type, the first-type operation instruction can be generated via a user operation terminal device having a second identity type and/or a third identity type and enter into the first processing device 1004;

the second-type operation instruction can be generated via a user operation terminal device having a second identity type, a third identity type and/or a fourth identity type and enter into the second processing device 1006;

the third-type operation instruction can be generated via a user operation terminal device having a second identity type and/or a fourth identity type and enter into the third processing device 1008.

According to a preferred embodiment of the present disclosure, a predetermined number of shares of first-type transaction objects obtained by a user having a third identity type based on a first-type operation instruction of the user is configured to obtain a timestamp by the first processing device 1004 such that the first-type transaction objects configured to obtain a timestamp is allowed to be transmitted to the second processing device 1006 after a preset time.

According to a preferred embodiment of the present disclosure, a user having a second identity type transmits the second-type transaction object information of a second-type transaction object obtained based on the first-type transaction object obtained by the first-type operation instruction or the second-type operation instruction of the user to the third processing device 1008.

According to a preferred embodiment of the present disclosure, when the price in the price identification information in the first-type transaction object information in the second processing device 1006 is greater than or greater than or equal to a first threshold, the first processing device 1004 allows for receiving a first-type transaction object information after a new preprocessing, or allows a user having the first identity type, the second identity type and/or the third identity type to transmit the first-type transaction object information of the first-type transaction object obtained by the user using the first acquisition instruction to the second processing device 1006.

According to a preferred embodiment of the present disclosure, when the price in the first-type transaction object information in the second processing device 1006 is less than or less than or equal to a second threshold, the second processing device 1006 generates a prompt instruction, and the prompt instruction is sent to a terminal device of the user having a second-type identity.

According to a preferred embodiment of the present disclosure, the first-type transaction object information after a new preprocessing is transmitted to the first processing device 1004 via a user operation terminal device having a first identity type.

The electronic apparatus of the present disclosure may include modules that correspond to various steps of the transaction processing method of the various embodiments described above.

As such, each or several of the above-described methods may be performed by respective modules, and the electronic apparatuses of the present disclosure may include one or more of these modules. The modules may be one or more hardware modules specifically configured to perform the respective steps, or be implemented by a processor configured to perform the respective steps, or be stored within a computer-readable medium for implementation by a processor.

As shown in FIG. 2, the electronic apparatus 1000 of the present disclosure may be implemented with a bus architecture. The bus architecture may include any number of interconnecting buses and bridges depending on the specific application of hardware and the overall design constraints. The bus 1100 connects various circuits including one or more processors 1200, memory 1300, and/or hardware modules together. The bus 1100 may also connect various other circuits 1400, such as peripherals, voltage regulators, power management circuits, external antennas, etc.

The bus 1100 may be an Industry Standard Architecture (ISA) bus, a Peripheral Component Interconnect (PCI) bus, an Extended Industry Standard Architecture (EISA) bus, or the like. The bus may be divided into an address bus, a data bus, a control bus, or the like. For ease of representation, only one connection line is shown in the figure, but it does not indicate that there is only one bus or one type of bus.

Any processes or method descriptions in the flowcharts or otherwise described herein may be understood to represent modules, segments, or portions of code that include one or more executable instructions for implementing the steps of a particular logical function or process, and the scope of the preferred embodiments of the present disclosure comprises additional implementations in which the functions may not be performed in the order shown or discussed, including in a substantially simultaneous manner or in an opposite order according to the functionality involved, which should be understood by those skilled in the art to which the embodiments of the present disclosure pertain. The processor performs various methods and processes described above. For example, the method embodiments of the present disclosure may be implemented as a software program tangibly embodied in a machine-readable medium, such as a memory. In some embodiments, some or all of the software programs may be loaded and/or installed via a memory and/or communication interface. One or more of the steps of the methods described above may be performed when a software program is loaded into the memory and executed by the processor. Alternatively, in other embodiments, the processor may be configured to perform one of the methods described above by any other suitable means (e.g., by means of firmware).

The logic and/or steps represented in the flowchart or otherwise described herein may be embodied in any readable storage medium for use by or in connection with an instruction execution system, apparatus, or device, such as a computer-based system, a processor-containing system, or other system that can fetch instructions from an instruction execution system, apparatus, or device and execute the instructions.

In the context of this specification, a “readable storage medium” may be any device that may contain, store, communicate, propagate, or transport a program for use by or in connection with an instruction execution system, apparatus, or device. More specific examples (a non-exhaustive list) of a readable storage medium include the following: an electrical connection (electronic apparatus) having one or more wires, a portable computer disk cartridge (magnetic device), a random access memory (RAM), a read-only memory (ROM), an erasable programmable read-only memory (EPROM or flash memory), an optical fiber device, and a portable read-only memory (CD ROM). In addition, the readable storage medium may even be a paper or other suitable medium on which the program can be printed, as the program can be electronically obtained, for example, by optical scanning of the paper or other medium, followed by editing, interpretation, or otherwise processing, if necessary, and then stored in memory.

It is to be understood that portions of the present disclosure may be implemented in hardware, software, or a combination thereof. In the above embodiments, a plurality of steps or methods may be implemented with software stored in a memory and executed by a suitable instruction execution system. For example, if implemented in hardware, and in another embodiment, a discrete logic circuit having a logic gate circuit for implementing logical functions on data signals, an application specific integrated circuit having suitable combinational logic gate circuits, a programmable gate array (PGA), a field programmable gate array (FPGA), etc., may be implemented in any of the following techniques, which are well known in the art.

Those of ordinary skill in the art will appreciate that all or part of the steps to implement the embodiments can be completed by means of programs instructing relevant hardware, and the programs may be stored in a readable storage medium, and the programs, when executed, include one or a combination of the steps of the method embodiment.

Furthermore, the various functional units in various embodiments of the present disclosure may be integrated in one processing module or may be separate physically present from each unit or may be integrated in one module with two or more units. The aforementioned integrated modules may be implemented in hardware, or in the form of software functional modules. An integrated module, if implemented in the form of a software functional module and sold or used as a standalone product, may also be stored in a readable storage medium. The storage medium may be a read-only memory, a magnetic or optical disk, or the like.

The present disclosure further provides an electronic apparatus, comprising: a memory storing an execution instruction; and a processor or other hardware module, the processor or other hardware module executing the execution instruction stored in the memory, whereby the processor or other hardware module performs the method described above.

The present disclosure further provides a readable storage medium having an execution instruction stored therein that, when executed by a processor, performs the method described above.

In addition, the terms “first” and “second” are used herein for purposes of description only and are not intended to indicate or imply relative importance or significance or implicitly indicate the number of indicated technical features. Thus, features defined with “first” and “second” may explicitly or implicitly include at least one of the features. In the description of the present application, “a plurality of” means at least two, for example, two, three, etc., unless specifically defined otherwise.

It should be understood by those skilled in the art that the above embodiments are merely for clearly illustrating the present disclosure, rather than limiting the scope of the present disclosure. Other modifications or variations can be made by those skilled in the art based on the above disclosure, and these modifications or variations remain within the scope of the present disclosure.

1. A transaction processing method, comprising:
preprocessing at least one first-type transaction object information, wherein the first-type transaction object information after being preprocessed comprises at least feature information and number of shares identification information;
transmitting the first-type transaction object information after being preprocessed to a first processing region, wherein the first-type transaction object information in the first processing region is processed based on at least one first-type operation instruction, the first-type operation instruction comprises obtaining predetermined number of shares of first-type transaction objects; updating the number of shares identification information of the first-type transaction object information in the first processing region based on at least one first-type operation instruction;
transmitting updated first-type transaction object information to the second processing region, wherein the first-type transaction object information in the second processing region is processed based on at least one second-type operation instruction, the second-type operation instruction comprises obtaining predetermined number of shares of first-type transaction objects; updating the number of shares identification information of the first-type transaction object information in the second processing region based on at least one second-type operation instruction; and
transmitting at least one second-type transaction object information to a third processing region, wherein the second-type transaction object information is processed based on at least one third-type operation instruction, the third-type operation instruction comprises obtaining predetermined number of second-type transaction objects; the second-type transaction object information comprises at least feature information and quantity information; updating the quantity information of at least one second-type transaction object information in the third processing region based on at least one third-type operation instruction;

2. The transaction processing method according to claim 1, wherein the second-type transaction object information is obtained based on the predetermined number of shares of first-type transaction object information obtained by at least one first-type operation instruction and/or at least one second-type operation instruction.

3. The transaction processing method according to claim 1, wherein the first-type transaction object information and the second-type transaction object information are different types of transaction object information.

4. The transaction processing method according to claim 2, wherein the first-type transaction object information further comprises identity identification information, and the second-type transaction object information comprises the identity identification information of the first-type transaction object information.

5. The transaction processing method according to claim 1, wherein the first-type transaction object information further comprises price identification information, the first-type operation instruction comprises a price sub-instruction; the price sub-instruction of the first-type operation instruction is compared with the price identification information of the first-type transaction object information in the first processing region, and if a price of the price sub-instruction is the same as a price in the price identification information or a difference between the price in the price sub-instruction and the price in the price identification information is within a preset range, the first-type transaction object information in the first processing region is processed by the first-type operation instruction.

6. The transaction processing method according to claim 5, wherein the second-type operation instruction comprises a price sub-instruction; the price sub-instruction of the second-type operation instruction is compared with the price identification information of the first-type transaction object information in the second processing region, and if a price of the price sub-instruction is the same as a price in the price identification information or a difference between the price in the price sub-instruction and the price in the price identification information is within a preset range, the first-type transaction object information in the second processing region is processed by the second-type operation instruction.

7. The transaction processing method according to claim 5, wherein the second-type transaction object information further comprises price identification information, the third-type operation instruction comprises a total price sub-instruction, and the total price sub-instruction of the third-type operation instruction is matched with the price identification information in the second-type transaction object information in the third processing region to enable the third-type operation instruction to obtain a predetermined number of second-type transaction objects.

8. The transaction processing method according to claim 5, wherein the second-type transaction object information further comprises price identification information, the third-type operation instruction comprises first-type transaction object information, and the price identification information and the number of shares identification information in the first-type transaction object information of the third-type operation instruction are matched with the price identification information in the second-type transaction object information in the third processing region to enable the third-type operation instruction to obtain a predetermined number of second-type transaction objects.

9. The transaction processing method according to claim 5, wherein the first-type transaction object obtained by the first-type operation instruction or the second-type operation instruction is partially or fully transmittable to the second processing region.

10. The transaction processing method according to any one of claim 1, wherein the price identification information in the first-type transaction object information of the first-type transaction object obtained by the first-type operation instruction or the second-type operation instruction can be modified such that the first-type transaction object information of the first-type transaction object obtained by the first-type operation instruction or the second-type operation instruction comprises modified price identification information.

11. The transaction processing method according to any one of claim 1, wherein the identity identification information is of a non-modifiable type.

12. A transaction processing system, comprising:
a preprocessing device for preprocessing at least one first-type transaction object information, wherein the first-type transaction object information after being preprocessed comprises at least feature information and number of shares identification information;
a first processing device, wherein the preprocessing device transmits the first-type transaction object information after being preprocessed to the first processing device, the first processing device processes the first-type transaction object information based on received at least one first-type operation instruction, the first-type operation instruction comprises obtaining predetermined number of shares of first-type transaction objects; the first processing device updates the number of shares identification information of the first-type transaction object information in the first processing device based on at least one first-type operation instruction;
a second processing device, wherein the first processing device transmits updated first-type transaction object information to the second processing device, the second processing device processes the first-type transaction object information based on received at least one second-type operation instruction, the second-type operation instruction comprises obtaining predetermined number of shares of first-type transaction objects; the second processing device updates the number of shares identification information of the first-type transaction object information in the second processing device based on at least one second-type operation instruction; and
a third processing device, wherein the third processing device receives at least one second-type transaction object information, the third processing device processes the second-type transaction object information based on received at least one third-type operation instruction, the third-type operation instruction comprises obtaining predetermined number of second-type transaction objects, the second-type transaction object information comprises at least feature information and quantity information; the third processing device updates the quantity information of at least one second-type transaction object information in the third processing device based on at least one third-type operation instruction.

13. An electronic apparatus, comprising:
a memory storing an execution instruction; and
a processor executing the execution instruction stored in the memory, whereby the processor performs the method according to claim 1.

14. A readable storage medium having an execution instruction stored therein, wherein the execution instruction is configured to perform the method according to claim 1 when executed by a processor.
